(19) United States
(12) Patent Application Publication
(10) Pub. No.: US 2019/0261621 A1
(43) Pub. Date: Aug. 29, 2019

(54) SYSTEM AND METHODS FOR ATTRACTING PREDATORY ANIMALS

(71) Applicant: BUSHNELL HOLDINGS, INC., Overland Park, KS (US)

(72) Inventors: Stephen Smith, Overland Park, KS (US); Jacob R. Thomason, Madison, MS (US)

(73) Assignee: BUSHNELL HOLDINGS, INC., Overland Park, KS (US)

(21) Appl. No.: 16/287,979

(22) Filed: Feb. 27, 2019

Related U.S. Application Data
(60) Provisional application No. 62/636,048, filed on Feb. 27, 2018.

(51) Int. Cl. A01M 31/00; A01M 31/06; A01M 29/16

(52) U.S. Cl. CPC A01M 31/004; A01M 31/002; A01M 29/10; A01M 29/16; A01M 31/06

(57) ABSTRACT

Systems and methods for attracting predatory animals using audible signals are described herein. The system may include an electronic caller device and a handheld remote controller. The system may provide up to 360° sound propagation across one or more devices wireless connected and linked to provide realistic sounds throughout an environment to realistically mimic sounds known to attract a predator. A handset or mobile device is provided with a user-interface for controlling, monitoring and recording information associated with the playback of the audio signals.

### CROSS REFERENCE TO RELATED APPLICATIONS

The present disclosure claims priority to U.S. Provisional Patent Application No. 62/636,048, filed on Feb. 27, 2018, the entire contents of which are hereby incorporated by reference.

### FIELD OF TECHNOLOGY

Aspects of the present disclosure relate to auditory signal generation and transmission, more particularly to systems and methods for attracting predatory animals using wide degree sound propagation of intuitively selected audible signals and a mobile device user-interface for controlling, monitoring and recording information.

### BACKGROUND

The popularity and necessity of hunting of predatory animals, such as coyotes, foxes and other wild carnivores, has increased in recent years. Increased predator population can have a debilitating effect on natural wildlife environments. Greater numbers of predatory animals lead to decreased populations of several prey animals that are popular game targets for hunters. Deer and elk populations may become limited due to over population of predators. Additionally, the increased population of predatory animals, coupled with a decrease in prey populations may lead to predators migrating towards towns and cities in search of food no longer found in the wild. Predators may pose a significant danger to children, pets and others in towns, cities and other human occupied areas.

Animal calls and sounds designed to attract predatory animals are known, however these systems are unidirectional discrete devices and provide inadequate enticement of predatory animals, i.e. such systems propagate sound in a single direction).

### SUMMARY

Embodiments of the present invention include systems and methods for attracting predatory animals using of one or more speaker devices configured to mimic a natural environment for prey and predator. According to one aspect of the disclosure, a predator calling system is provided. The system may include at least one speaker assembly, which may include a plurality of speakers configured to emit sound, a memory configured to store at least one of a plurality of audio files mimicking an animal, a speaker assembly processor configured to play the at least one of a plurality of audio files from the speaker; and a wireless transmitter configured to communicate with a handset. The handset may include a display, a user-interface, and a handset processor. The handset processor may be configured to present on the display a list the at least one of a plurality of audio files mimicking an animal and receive a selection from a user of an audio file for playback. The handset processor may further be configured to instruct the speaker assembly processor to play the selected audio file from the speaker.

According to another aspect of the disclosure, a method of attracting a predatory animal is provided. The method may include deploying a first and second speaker assembly in an environment. Each speaker assembly may include at least one speaker, a memory, a processor and a wireless transmitter. Content of the memory of at least one of the speaker assemblies may be accessed from a handset. The handset may include a user-interface configured to display the content of the memory on a handset display. The first and second speaker assemblies may be linked for synchronous playback. Using the handset, at least one audio file mimicking an animal may be selected. The at least one audio file may be synchronously broadcasting from the first and second speaker assemblies.

According to another aspect of the disclosure, a system for attracting a predatory animal to a target area may include a first speaker assembly disposed at a first location in the target area and a second speaker assembly disposed at a second location in the target area. Each of the first and second speaker assemblies may include a plurality of speakers configured to emit sound in a range up to 360°. The speaker assemblies may further include a memory configured to store at least one of a plurality of audio files mimicking an animal, a speaker assembly processor configured to play the at least one of a plurality of audio files from the speaker synchronously with other speaker assemblies, and a wireless transmitter configured to communicate with a handset. The handset may include a display, a user-interface, and a handset processor. The handset processor may be configured to present on the display a list the at least one of a plurality of audio files mimicking an animal and receive a selection from a user of an audio file for playback. The handset processor may instruct the speaker assembly processor to play the selected audio file from the speaker.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 depicts an illustrative hunting environment according to one aspect of the disclosure.

FIG. 2(a) depicts a perspective view of an electronic calling device according to one aspect of the disclosure.

FIG. 2(b) depicts a side view of the electronic calling device of FIG. 2(a), according to one aspect of the disclosure.

FIG. 2(c) depicts a top-view of an electronic calling device according to one aspect of the disclosure.

FIG. 2(d) depicts a side-view schematic diagram of an electronic device according to one aspect of the disclosure.

FIG. 3(a) is a top-view schematic diagram of a speaker configuration according to one aspect of the disclosure.

FIG. 3(b) depicts a top-view schematic diagram of an alternative speaker configuration according to one aspect of the disclosure.

FIG. 4(a) depicts a perspective view of an electronic calling device according to one aspect of the disclosure.

FIG. 4(b) depicts a side-view of the electronic calling device of FIG. 4(a) according to one aspect of the disclosure.

FIG. 4(c) depicts a side-view of an electronic calling device according to one aspect of the disclosure.

FIG. 5(a) depicts a side-view of an electronic calling device according to one aspect of the disclosure.

FIG. 5(b) depicts a side-view schematic of the electronic calling device of FIG. 5(a) according to one aspect of the disclosure.

FIG. 6(a) depicts a side-view of an electronic calling device according to one aspect of the disclosure.

FIG. 6(b) depicts a side-view of the electronic calling device of FIG. 6(a) including a decoy object according to one aspect of the disclosure.

FIG. 6(c) depicts a side-view of the electronic calling device of FIG. 6(a) including a mounting stick according to one aspect of the disclosure.

FIG. 7(a) depicts a side-view of a nested set of electronic calling devices according to one aspect of the disclosure.

FIG. 7(b) depicts an expanded view of a nesting mechanism according to one aspect of the disclosure.

FIG. 7(c) depicts a perspective view of an anti-sheer fixture according to one aspect of the disclosure.

FIG. 8 depicts a computer system according to one aspect of the disclosure.

FIG. 9(a) depicts a front-view of a remote handset device according to one aspect of the disclosure.

FIG. 9(b) depicts a side-view of a remote handset device according to one aspect of the disclosure.

FIG. 10(a) depicts a mobile device and electronic calling interface according to one aspect of the disclosure.

FIG. 10(b) depicts a mobile device electronic calling interface according to one aspect of the disclosure.

FIG. 11 depicts a method of attracting a predatory animal according to one aspect of the disclosure.

### DETAILED DESCRIPTION

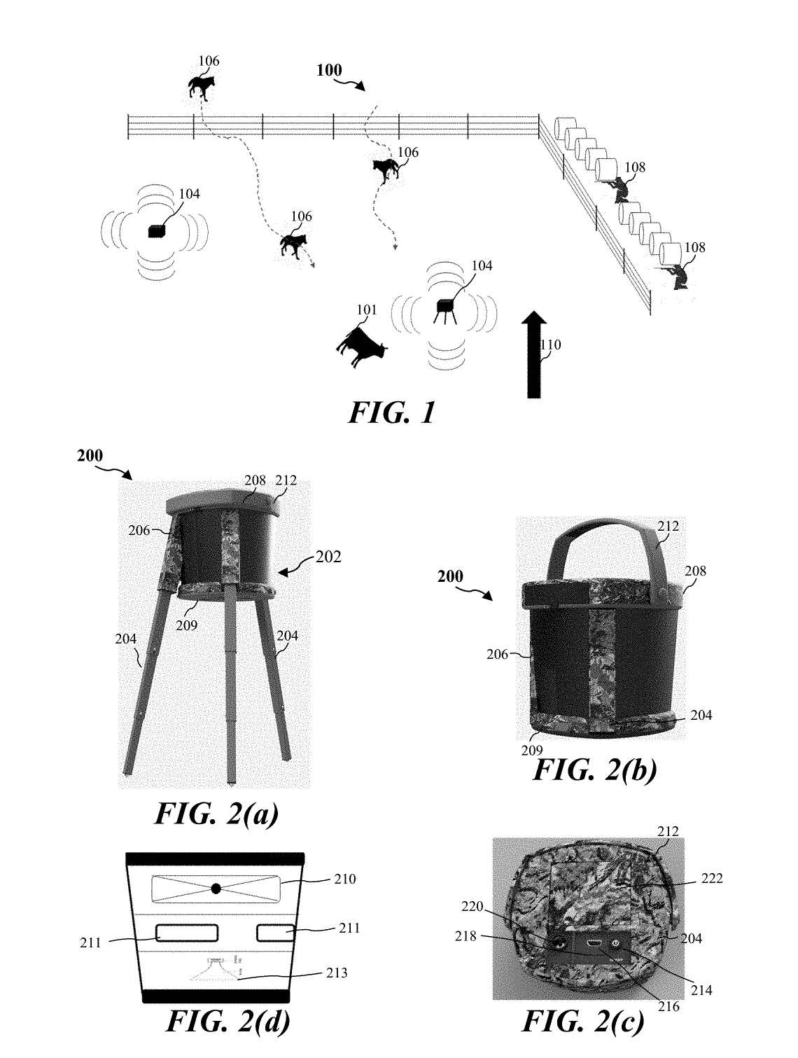

The present disclosure provides improved systems and methods for attracting predatory animals to a localized area using audible signals transmitted from one or more speaker devices configured to mimic a natural environment for prey and predator. FIG. 1 depicts one such exemplary environment 100, according to one aspect of the present disclosure. One or more electronic calling devices 102, 104 (“eCallers”) may be strategically placed in the environment 100 to mimic the sound of a prey animal often sought by a predatory animal 106. The eCallers 102, 104 may be programmed to transmit, emit or otherwise broadcast sound signals known to attract a desired predatory animal 106. For example, the eCallers 102, 104 may broadcast an audible sound of a wounded or distressed prey animal 101.

The eCaller devices 102, 104 may be configured to broadcast the sounds of any number of attractive calls or signals that, upon a predatory animal hearing, may draw the predator into the staged environment 100 giving a hunter 108 a clear view and aim line at the predatory animal 106. As described below in more detail the eCaller devices 102, 104 may be configured to broadcast signals in a range up to 360°. Additionally, the eCaller devices 102, 104 may take advantage of the wind conditions 110 in the environment and place the eCaller devices 102, 104 in locations upwind of where the hunters 108 expect the predator to arrive, thus allowing the wind to carry further the audible signals broadcast. The eCaller devices 102, 104, as described herein, may be paired or jointly configured to coordinate and broadcast audio in concert with each other to mimic more accurately the sound of a prey animal and its natural movement patterns. Adjusting level, speed and dispersion of the audio may give the predator a sense of a moving prey animal, further attracting the predator to into a target area. The eCaller devices 102, 104 may be further configured to communicate with a handheld remote or mobile device running application software that facilitates the selection and playback of preprogrammed and prerecorded calls.

According to one aspect of the disclosure, an eCalling system may include at least one speaker assembly and a handset. The speaker assembly may include a speaker, a memory, playback processor and a wireless transmitter to communicate with the handset. As used herein, a handset may include a dedicated remote control operating at 915 MHz, or may be a mobile device, such as a smart phone, tablet, phablet, or the like communicating over a low energy spectrum, such as Bluetooth. Other wireless protocols and frequency bands may also be used to establish communication between the eCaller devices, handsets, or other equipment. FIGS. 2(a)-(d) illustrate aspects of a full-sized eCaller 200 according to an aspect of the disclosure. The full-sized eCaller 200 may include a speaker assembly 202.

As shown in FIG. 2(a) the speaker assembly 202 may include one or more extendable and locking legs 204. The extendable legs 204 may be adjustable in length and provide a technical advantage of raising the speaker to a height that is free from obstruction by surrounding vegetation or other low-lying obstacles. The speaker assembly 202 may include one or more speakers and associated driving circuitry and hardware as well as a wireless receiver (not shown). The internal hardware of the speaker assembly 202 may be encased or enclosed in a mesh or other porous body 206 configured to allow sound to travel from the internal speakers outwardly from the from speaker assembly 202. The body 206 may include a top portion 208 and a bottom portion 209. The top portion 209 may include a pivotable handle 212 that pivots upward for carrying the eCaller and may be pivoted down about the top portion 208 when deployed or stored. The top portion 208 and bottom portion 209 may be outfit with padded supports such as covers, bases, struts or the like to protect the speakers and internal hardware and provide added support to the speaker assembly 202. According to one aspect, the padded supports of the top portion 208 and the bottom portions 209 may be camouflaged to help hide the eCaller in the surrounding environment.

As shown in FIG. 2(b), the legs 204 may be retracted for ease of carrying, packing or storing. Depending on the environment in which the eCaller is deployed the hunter or user may wish to place the device low to the ground, in which case the eCaller may be deployed in the environment with the legs 204 fully retracted. The legs may also be extended or retraced individually to allow for non-standard configurations where one or more legs are set at different lengths. Doing so may accommodate uneven terrain or allow a unique projection angle of the audio. FIG. 2(c) depicts a top-down view of the full-sized eCaller 200. The top portion 208 may include a power/volume control 214, communication input/output port 216, memory card slot 218, and a decoy cable port 220, described in further detail below. As described below, memory card slot 218 may be configured to receive removable memory devices such as SD, miniSD and microSD cards. The top portion may further include an access panel 222. The access panel 222 may provide access to the speaker assembly and other internal compartments, such as a storage compartment or the like, inside of the device. The top portions of the full-sized eCaller is substantially similar to those of the eCaller configurations described below.

FIG. 2(d) depicts a side-view of a schematic diagram of a full-sized eCaller according to one aspect. One or more speakers 210 may be disposed at or near the top of the speaker assembly. As described below, the speakers may be configured and arranged to provide up to 360° of sound coverage. One or more passive radiators 211 may be disposed below the speakers 210. The passive radiators 211 may allow for air-flow through the speaker assembly to improve acoustic performance. A low/mid-range speaker, such as a subwoofer may be disposed at or near the bottom of the speaker assembly. According to one aspect, the low/mid-range speaker may be aimed downward at the ground to provide more accurate and enhanced low-frequency sound transmission.

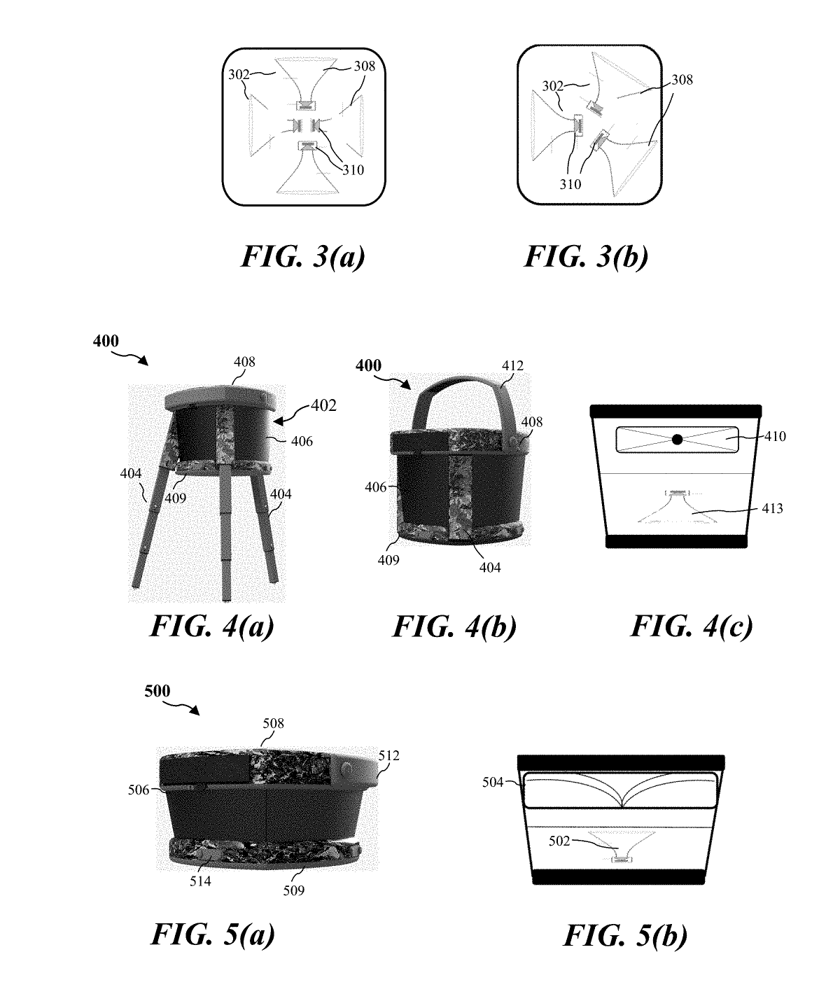

FIGS. 3(a) and 3(b) depict schematics of potential speaker configurations of the eCaller speaker assembly. FIG. 3(a) depicts a top-view of the speaker assembly including four full-range speakers 302. The four full-range speakers 302 may be positioned in the speaker assembly to emit sound in a 360° range. Alternatively, as shown in FIG. 3(b) three full-range speakers may be implemented and positioned to provide the same or similar 360° coverage. According to another aspect of the disclosure, the speaker assembly and the speakers contained therein may be configured to broadcast audio to a range less than 360°, for example at 270° or other range as desired and suited for different environments. A 270° configuration may be accomplished by cutting power to one of the speakers (in either the four-speaker arrangement or the three-speaker arrangement). For example, if an environment includes several obstacles or barriers on one side of the eCaller, a potential echo off of those obstacles may distort or disrupt the audio signals and become less-effective. In such a scenario, a speaker assembly with a more targeted dispersion range may be used.

Each full-range speaker 302 may include a flare 308 and a driver 310, as are known in the art. According to one aspect of the disclosure, the full-range speakers 302 may be horn speakers. A low/mid-range speaker (not shown), according to one aspect may include a sub-woofer, as known in the art, to complement the full-range speakers 302 and provide a deeper, lower frequency response of the audio signals being transmitted. In some configurations, the speaker assembly of the full-sized eCaller may provide a frequency response range of about 85 Hz to 16 kHz and a sound pressure level (SPL) greater than 110 dB at full power at the device and at least 64 dB at a range of about 500 m. One skilled in the art will appreciate, however, that other speaker specifications and frequency ranges may be used. The acoustic disperser 304 may be disposed between the full-range speakers 302 and low/mid-range speaker 306 to further assist the transmission and broadcast of the audio signals outward from the speaker assembly and into the environment.

According to another aspect of the present disclosure, a mid-sized eCaller may be used to provide a smaller audio output than that of the previously described full-sized eCaller. FIGS. 4(a)-(c) depict a mid-sized eCaller 400 according to one aspect of the disclosure. Like the full-sized eCaller, the mid-sized eCaller may include a speaker assembly 402 with retractable legs 404, a porous body 406, a handle 412, and camouflaged padded supports around a top portion 408 and a bottom portion 409. The mid-sized eCaller 400 carries much of the functionality of the full-sized eCaller, with a smaller sound output and form-figure. FIG. 4(c) depicts a side-view of a schematic diagram of the speaker assembly of a mid-sized eCaller. According to one aspect, the mid-sized eCaller 400 may include three or four full-range horn speakers and a low/mid-range speaker giving the speaker assembly a frequency response range of 100 Hz to 16 kHz and an SPL greater than 100 dB at full power at the device and at least 60 dB at a range of about 500 m. The speaker assembly of the mid-sized eCaller 400 may also include a low/mid-range speaker 413 as known in the art, to complement the frequency range of the full-range speakers.

According to another aspect of the present disclosure, a small eCaller may be used to provide a yet smaller audio output than that of the previously described full-sized eCaller. FIGS. 5(a)-(b) depict a small eCaller 500 according to one aspect of the disclosure. Like the full-sized eCaller and the mid-sized eCaller, the small eCaller may include a porous body 506 enclosing the speaker assembly, a handle 512, and camouflaged padded supports about a top portion 508 and bottom portion 509. The bottom portion 509 may further include a nesting mechanism, as described further below, to allow one or more eCaller devices to be attached to each other for transport and storage.

FIG. 5(b) depicts a schematic diagram of the speaker assembly of the small eCaller 500, including a horn speaker 502 and an acoustic disperser 504. Unlike the full-sized and mid-sized eCallers, the small eCaller may only include a single full-range speaker 502, allowing the acoustic disperser to project the audio output of the single speaker 502 outward at a range up to 360°. Also, unlike the full-sized and mid-sized eCallers, the small eCaller 500 may not include a low/mid-range speaker, or retractable legs. The small eCaller 500 carries much of the functionality of the full-sized and mid-sized eCallers, with a smaller sound output and form-figure. According to one aspect, the speaker assembly of the small eCaller 500 may include a frequency response range of 100 Hz to 15 kHz and an SPL greater than 95 dB at full power at the device and at least 50 dB at a range of about 500 m.

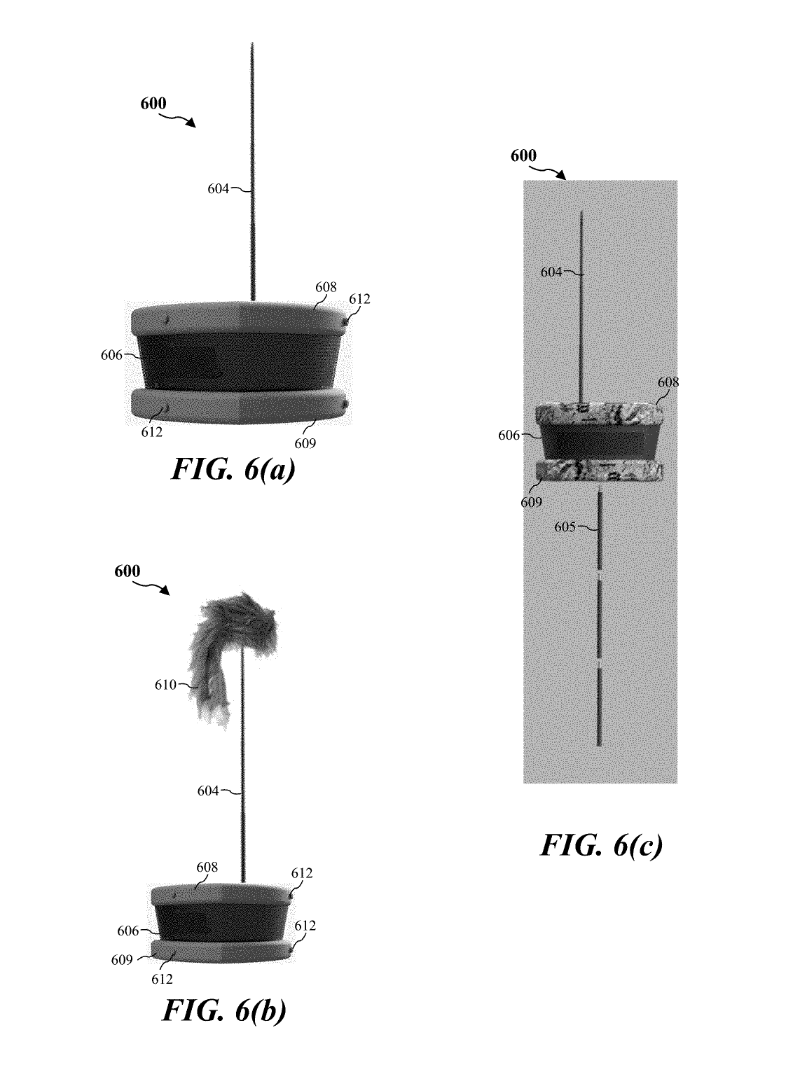

According to another aspect of the present disclosure, a decoy device may include additional features to further attract a predatory animal. FIGS. 6(a)-(c) depict aspects of a decoy device 600. The decoy eCaller 600 may include a speaker assembly (not shown), body portion 606 and padded supports about top portion 608 and bottom portion 609, as described herein. The top portion 608 may further include nesting pegs 612 or other protrusions, studs or the like that, as described in further detail below, cooperate with the nesting mechanisms of other eCallers to securely connect to each other for transport and storage. While the decoy device 600 may not include a speaker assembly, such as those previously described, one skilled in the art will appreciate that a speaker assembly may be included given the form-figure of the device. The decoy device 600 may include a stick mount 605, or other support mechanism known in the art, to support the body of the decoy device in the field. For example, the stick mount 605 may be collapsible or modular and attach to the bottom of the device. The distal end of the stick mount may be inserted into the ground allowing the decoy device 600 to remain elevated in the field. The modular configuration of the stick mount 605 may allow the user to set different heights to which the device may be elevated depending on the surrounding environment.

The decoy device 600 may further include a decoy attachment cable 604. The decoy attachment cable 604 may be a rigid or semi-rigid pole, strut, or the like, that may be inserted into the decoy cable port of the top portion of the device, as previously described. As shown in FIG. 6(c) a decoy device 610 such as an animal pelt, natural or synthetic, may be attached to a distal end of the decoy cable 604. According to one aspect, when the decoy device 600 is deployed on the ground or other low-lying height, such as in a field or meadow with tall grass, the decoy device 610 may further attract the predatory animal's visual attention in addition to its audible attention. According to one aspect, the decoy cable may be driven by a motor, actuator or other mechanical device to rotate, spin, or otherwise move to mimic the motion of a prey animal in the field. Internal hardware, such as a motor, controller, and the like, which are known in the art, may be disposed within the internal body of the decoy device and operatively connected to the decoy cable port on the top portion of the device. The decoy device 600 may further include additional storage capacity to carry and store the decoy cable 604 and the decoy stick mount 605.

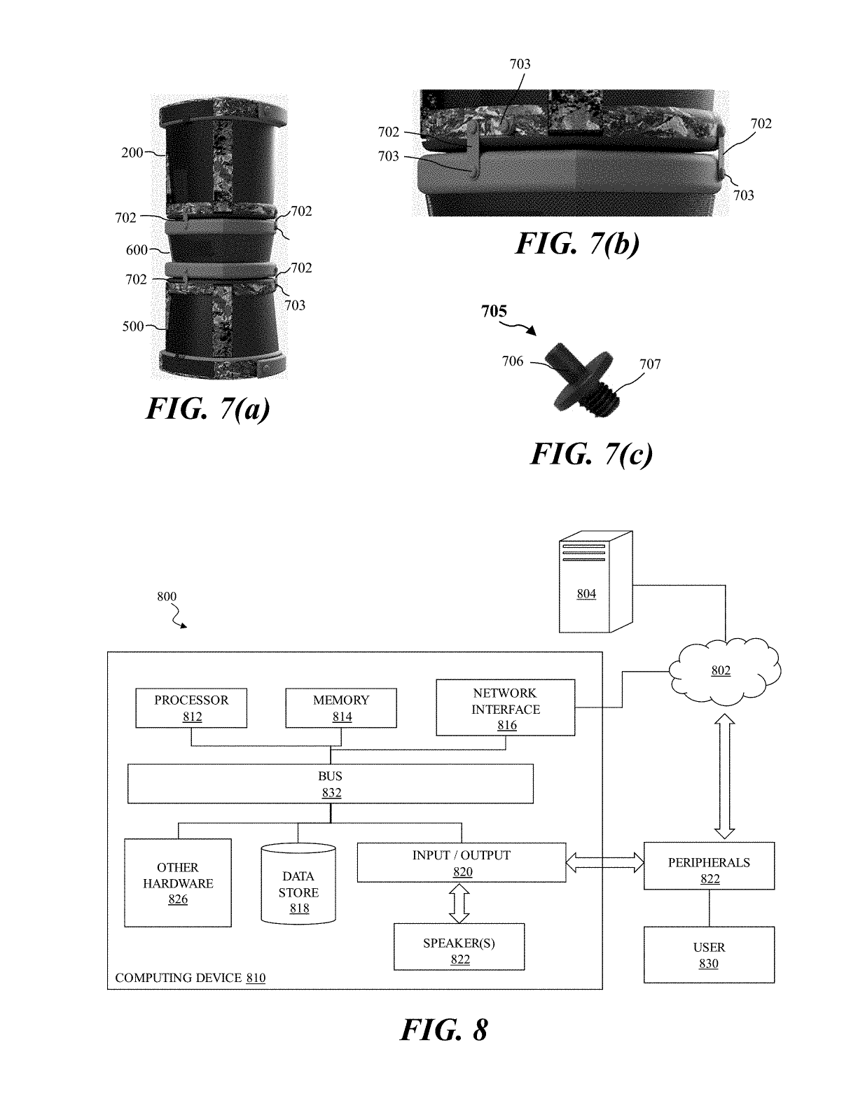

According to aspects of the present disclosure, the eCaller devices described herein may be modular and deployed in conjunction with each other throughout an environment to create a more complete and accurate audible signal to attract a predatory animal. The eCaller devices described herein may be nested or attached to each other for easy transport into the environment in which they will be deployed. FIG. 7(a) depicts a nested configuration of various-sized eCallers 200, 500 and a decoy 600, as described herein. A full-sized eCaller device 200 is nested with a decoy device 600 and a mid-sized eCaller device 500. According to one aspect a latching mechanism 702 may be attached to the bottom portion of the full-sized eCaller 200 and the bottom portions of the eCaller devices 200, 500. As shown, the mid-sized eCaller 500 has been inverted to allow for the latching mechanism to provide a nesting connection. FIG. 7(c) depicts an expanded view of the latching mechanisms, according to one aspect of the present disclosure. The latching mechanism 702 may include a pivotable plate 704 affixed to a nesting peg 703 of the bottom portions of the eCaller devices. Similarly, nesting pegs 703 may extend from the top portion of the eCaller or decoy device. The pivotable plate may pivot about the nesting peg 703 to extend above or below the respective padded support of the eCaller devices where the other end of the pivotable plate may be secured to a nesting peg 703 of the proximate device, linking the devices together for transport or transport.

FIG. 7C depicts an anti-sheer peg 705 that may assist in nesting the eCaller and decoy devices. The anti-sheer peg 705 may include a threaded shaft 707 and a non-threaded shaft 706. According to one aspect, the threaded shaft 707 of the anti-sheer peg may be threaded into a corresponding threaded recess in the bottom portion of an eCaller device. The threaded recess may also support other attachments, such as a stick mount or other support. The non-threaded shaft 706 may then be aligned with the threaded shaft on the bottom portion of a second eCaller or the top or bottom portion of a decoy device, thus providing another linkage between the devices. The decoy device, according to one aspect may use the recess into which the decoy cable port to receive the anti-sheer peg 705. The anti-shear pegs 705 prevent lateral movement of the linked devices, relative to each other, that the pivoting latching mechanisms 702 may not provide. When the eCallers and/or decoys are separated and deployed, the pivotable plate 704 may be pivoted about 90° such that the pivotable plate is no longer extending beyond edge of the padded support and the anti-sheer pegs may be removed and stored for later use.

As described herein, aspects of the present disclosure provide one or more eCaller devices configured to broadcast, or otherwise transmit audio signals from one or more speakers into an environment to attract predatory animals. The speaker assemblies of the eCaller devices may include a computer system 800 as shown in FIG. 8. In general, the computer system 800 may include a computing device 810, such as a special-purpose computer designed and implemented for directing and controlling the output of audio signals. The computing device 810 may be or include data sources, client devices, and so forth. For example, the computing device 810 may include a microprocessor installed and disposed within an internal area of an eCaller device. In certain aspects, the computing device 810 may be implemented using hardware or a combination of software and hardware. The computing device 810 may be a standalone device, a device integrated into another entity or device, a platform distributed across multiple entities, or a virtualized device executing in a virtualization environment.

The computing device 810 may communicate across a network 802. The network 802 may include any data network(s) or internetwork(s) suitable for communicating data and control information among participants in the computer system 800. This may include public networks such as the Internet, private networks, and telecommunications networks such as the Public Switched Telephone Network or cellular networks using cellular technology and/or other technologies, as well as any of a variety other local area networks or enterprise networks, along with any switches, routers, hubs, gateways, and the like that might be used to carry data among participants in the computer system 800. The network 802 may also include a combination of data networks and need not be limited to a strictly public or private network.

The computing device 810 may communicate with an external device 804. The external device 804 may be any computer or other remote resource that connects to the computing device 810 through the network 802. This may include any of the servers or data sources described herein, including servers, content providers or other sources for electronic or audio information to be used by the devices as described herein.

In general, the computing device 810 may include a processor 812, a memory 814, a network interface 816, a data store 818, and one or more input/output interfaces 820. The computing device 810 may further include or be in communication with peripherals 822 and other external input/output devices that might connect to the input/output interfaces 820.

The processor 812 may be any processor or other processing circuitry capable of processing instructions for execution within the computing device 810 or computer system 800. The processor 812 may include a single-threaded processor, a multi-threaded processor, a multi-core processor and so forth. The processor 812 may be capable of processing instructions stored in the memory 814 or the data store 818.

The memory 814 may store information within the computing device 810. The memory 814 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 814 may store program instructions, program data, executables, and other software and data useful for controlling operation of the computing device 810 and configuring the computing device 810 to perform functions for a user. The memory 814 may include a number of different stages and types of memory for different aspects of operation of the computing device 810. For example, a processor may include on-board memory and/or cache for faster access to certain data or instructions, and a separate, main memory or the like may be included to expand memory capacity as desired. All such memory types may be a part of the memory 814 as contemplated herein.

The memory 814 may, in general, include a non-volatile computer readable medium containing computer code that, when executed by the computing device 810 creates an execution environment for a computer program in question, e.g., code that constitutes processor firmware, a protocol stack, a database management system, an operating system, or a combination of the foregoing, and that performs some or all of the steps set forth in the various flow charts and other algorithmic descriptions set forth herein. While a single memory 814 is depicted, it will be understood that any number of memories may be usefully incorporated into the computing device 810.

The network interface 816 may include any hardware and/or software for connecting the computing device 810 in a communicating relationship with other resources through the network 802. This may include remote resources accessible through the Internet, as well as local resources available using short range communications protocols using, e.g., physical connections (e.g., Ethernet), radio frequency communications (e.g., Wi-Fi, Bluetooth), optical communications, (e.g., fiber optics, infrared, or the like), ultrasonic communications, or any combination of these or other media that might be used to carry data between the computing device 810 and other devices. The network interface 816 may, for example, include a router, a modem, a network card, an infrared transceiver, a radio frequency (RF) transceiver, a near field communications interface, a radio-frequency identification (RFID) tag reader, or any other data reading or writing resource or the like.

The network interface 816 may include any combination of hardware and software suitable for coupling the components of the computing device 810 to other computing or communications resources. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 802 such as the Internet. This may also include hardware/software for a WiMax connection or a cellular network connection (using, e.g., CDMA, GSM, LTE, or any other suitable protocol or combination of protocols). The network interface 816 may be included as part of the input/output devices 820 or vice-versa.

The data store 818 may be any internal memory store providing a computer-readable medium such as a disk drive, an optical drive, a magnetic drive, a flash drive, or other device capable of providing mass storage for the computing device 810. The data store 818 may store computer readable instructions, data structures, program modules, and other data for the computing device 810 or computer system 800 in a non-volatile form for relatively long-term, persistent storage and subsequent retrieval and use. For example, the data store 818 may store an operating system, application programs, program data, databases, files, and other program modules or other software objects and the like.

The input/output interface 820 may support input from and output to other devices that might couple to the computing device 810. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also include an infrared interface, RF interface, magnetic card reader, or other input/output system for wirelessly coupling in a communicating relationship with other local devices. It will be understood that, while the network interface 816 for network communications is described separately from the input/output interface 820 for local device communications, these two interfaces may be the same, or may share functionality, such as where a USB port is used to attach to a Wi-Fi accessory, or where an Ethernet connection is used to couple to a local network attached storage. The input/output interface 820 may further output audio signals to the speakers 822 of the eCaller speaker assembly, as described herein.

A peripheral 822 may include any device used to provide information to or receive information from the computing device 800. This may include human input/output (I/O) devices such as a keyboard, a mouse, a mouse pad, a track ball, a joystick, a microphone, a foot pedal, a camera, a touch screen, a scanner, or other device that might be employed by the user 830 to provide input to the computing device 810. This may also or instead include a display, a printer, a projector, a headset or any other audiovisual device for presenting information to a user. The peripheral 822 may also or instead include a digital signal processing device, an actuator, or other device to support control of or communication with other devices or components. In one aspect, the peripheral 822 may serve as the network interface 816, such as with a USB device configured to provide communications via short range (e.g., Bluetooth, Wi-Fi, Infrared, RF, or the like) or long range (e.g., cellular data or WiMax) communications protocols. In another aspect, the peripheral 822 may augment operation of the computing device 810 with additional functions or features, such as a global positioning system (GPS) device, or other device. In another aspect, the peripheral 822 may include a storage device such as a flash card, USB drive, or other solid-state device, or an optical drive, a magnetic drive, a disk drive, or other device or combination of devices suitable for bulk storage. More generally, any device or combination of devices suitable for use with the computing device 800 may be used as a peripheral 822 as contemplated herein.

Other hardware 826 may be incorporated into the computing device 800 such as a co-processor, a digital signal processing system, a math co-processor, a graphics engine, a video driver, a camera, a microphone, additional speakers, and so forth. The other hardware 826 may also or instead include expanded input/output ports, extra memory, additional drives, and so forth.

A bus 832 or combination of busses may serve as an electromechanical backbone for interconnecting components of the computing device 800 such as the processor 812, memory 814, network interface 816, other hardware 826, data store 818, and input/output interface. As shown in the figure, each of the components of the computing device 810 may be interconnected using a system bus 832 in a communicating relationship for sharing controls, commands, data, power, and so forth.

The eCallers described herein may be designed and configured to be wirelessly deployed in the environment, including communications and power. Aspects of the devices described herein include power management and sourcing from replaceable and/or rechargeable power sources, including batteries and the like. According to one aspect, the eCallers may be powered by Lithium-ion Polymer (LiPO) batteries. Alternatively, the eCallers may also or instead be powered by alkaline or other battery types.

Additionally, the eCallers described herein are designed and configured to withstand harsh environments, including wind, rain and snow. According to one aspect, the eCallers may have an Ingress Protection (IP) rating of at least 55, protecting the internal software, hardware and other components from wind, dust, and water.

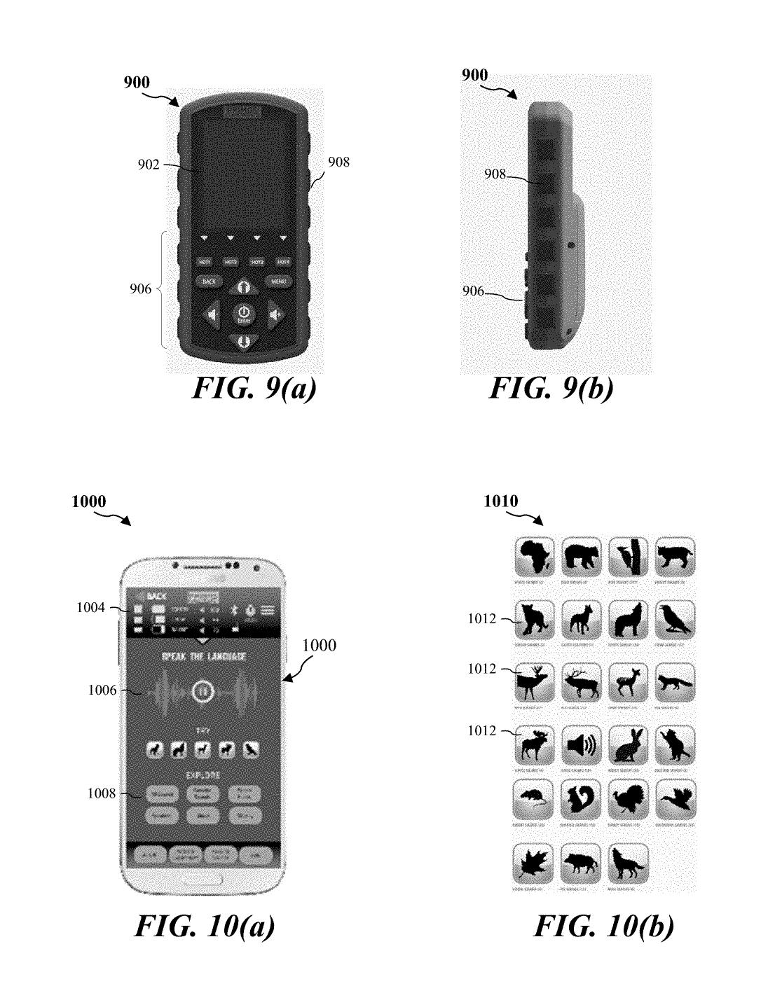

As described herein, the eCaller devices may communicate with a remote handset to receive configuration and playback instructions. FIGS. 9(a)-(b) depict a front and side-view, respectively of an illustrative handset 900 according to one aspect of the present disclosure. The handset according to one aspect may communicate with the eCaller (or decoy device) using RF signals at 915 MHz. Alternatively, the handset may be a mobile device, such as a mobile telephone, tablet, phablet, PDA, or the like, configured with an application to establish communication (such as a Bluetooth connection) and control the operation of the eCaller devices. The handset 900 may be in the form of a computing device, as previously described, including internal hardware and software. The handset 900 may communicate wirelessly with the computing device of the eCaller, such as via Bluetooth, Wi-Fi, Cellular broadcast, or other suitable communication protocol. The handset 900 may be sized and shaped to accommodate a user-friendly grip when out in the environment. For example, the handset 900 may include rubberized grips 908 to facilitate a user's grip of the device while wearing gloves.

The handset 900 may include a display 902 for presenting information and options to the user and one or more user inputs 906. The display may present information transmitted from the eCaller or another networked device, where the handset may act as an intermediary device between a server and the eCaller. For example, the display may present available audio files for playback and other related data. The display may present a user interface that is configured to show categorized information in any number of ways. For example, the user interface may categorize the audio files for selection by the desired predatory animal being sought. The user interface may organize the audio files by the type of prey animal the user desires to mimic.

The handset 900 may include one or more user inputs 906 to navigate through the information on the display and set-up and control the eCallers being deployed. The user inputs 906 may be hard-coded, dedicated keys, or may be soft keys presented dynamically on the handset display 900. The user inputs 906 may include power controls, playback controls, volume controls, navigational buttons, presets, or other such inputs to configure and operate the features of the eCaller.

The handset 900 may also present on the display 902 other deployed and available eCallers with which it may communicate. A user may link one or more of the available eCallers such that setting and playback controls entered in to the handset may be applied to all linked eCallers. Internal hardware and software in the eCaller computing devices may determine sound and other acoustic settings for playback based on the number and capabilities of the other linked eCallers. For example, if one eCaller device is closer to the target area to which the predatory animal is being coaxed, that eCaller may output sound at a higher level than one farther away from the target area. The sound output from the eCallers may be coordinated and synchronized across time and distance to provide an audio output indicative of a prey animal at a single location. The system processor may also be configured to establish the connection between the speaker assemblies and the mobile device. The processor may be configured to synchronously play audio files from the first and second speaker. Synchronization between the speaker assemblies may not necessarily indicate that the audio files are played back in lock-step with each other. Rather, as used herein synchronization may indicated that the playback of one or more audio files may be linked according to time, sound level, speed, and other settings to more accurately provide surround sound throughout the environment and thus simulate a virtual location of a prey animal in a target area. Additionally, different audio files may be played simultaneously or sequentially across and between the deployed eCallers. The coordinated and synchronous control of the playback on each of the eCallers in the deployment enhances the replication of the sound of natural animal sound and movement, providing a more realistic audio pattern and further enticing a predator to the area.

According to another aspect of the present disclosure, a mobile device configured with a software application may be used in place of a dedicated handset. FIGS. 10(a)-(b) depict illustrative user interfaces of a mobile application running on a mobile device 1000. The mobile device 1000 may include a display, a user-interface and a mobile device processor (not shown). The mobile device 1000 may be a smartphone such as an iPhone or Android smartphone. As shown in FIG. 10(a), the application may present an operational user interface 1002 to a user during active operation of the eCaller. According to one aspect, a configuration panel 1004 may display the current deployment configuration and information regarding the linked eCallers in the environment. Such information may include the number, type, battery level, playback status, network communication status or the like.

A playback portion 1006 of the user-interface may be configured to present on the display active or dynamic information regarding the current playback operation of the deployed and linked eCallers. For example, the playback panel 1004 may include an identifier showing the audio file being played back, playback control buttons, such as pause, play, remind, fast-forward, playback speed, or the like. The playback panel may also include a graphical display of the audio signal being played. A navigation panel 1008 may include one or more buttons or keys configured to allow the user to quickly access other menus, audio files, settings or the like. The navigation panel may allow the user to navigate and select audio profiles, preprogrammed audio hunts, or the like from the eCaller's memory, the application or mobile device's memory, or a third-party provider of additional content, including other audio and associated data not previously procured by the user. The operational user-interface 1002 may also include a sharing function allowing the user to post or share the devices configuration and data with another user. The sharing function may allow the user to post on social media or email, text, or otherwise communicate information about the eCallers and their configuration.

FIG. 10(b) depicts a menu interface 1010 according to an aspect of the present disclosure. The menu interface 1010 may present one or more category keys 1012 of content and data to explore. For example, category keys may be programmed to link to audio files and associated data according to the region of the world, or geographic area, the user may be hunting. The menu interface 1010 may also provide category keys 1012 related to audio files and associated data according to a type of predator, prey animal, season, or other classifier.

The handsets or mobile device applications may link the user to one or more databases or libraries storing audio files and associated data. Such data may include pre-recorded expert sounds mimicking the calls and sounds or predatory or prey animals. These audio files and associated data may be procured and downloaded from a remote server or library and transmitted to the eCallers for storage and playback. The handset and eCallers may be configured to play the audio files in a predetermined and sequential order such as a playlist stored on the mobile device or in the memory of the speaker assembly. A user may predetermine the order prior to deployment and upon beginning the hunt, direct the eCaller to play out the first audio file in the sequence, subsequently followed by each audio file in the playlist. According to one aspect of the disclosure the eCallers and handsets may be configured to organize and playback audio files from third-parties or audio files encoded according to proprietary, non-public audio formats.

According to one aspect, the eCaller system may be able to record and log various data points experienced during the use of the system. For example, the system may record and log the identification of the audio files played, the times and durations those files were played, environmental factors including time of day, temperature, humidity, or other similar weather information obtained from sensors placed and configured in the environment or on the eCaller devices. The information recorded and logged may be of value to a user to replicate similar environments in the future or study certain aspects about the environment that may need to be changed to ensure a more successful hunt in the future.

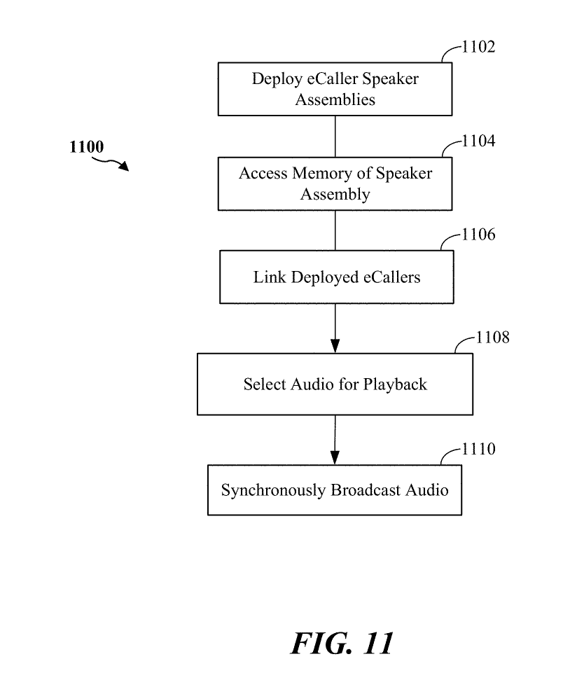

According to one aspect of the present disclosure a method of attracting a predatory animal is provided. FIG. 11 depicts an illustrative flow diagram of a method 1100 for attracting a predatory animal. As shown in block 1102, and previously described herein, one or more eCallers may be deployed in an environment where a predatory animal is known to prey. The eCallers may be deployed at multiple locations throughout the environment to fully create realistic mimicry of a virtual prey animal. The size and scope of the environment may dictate the appropriate configuration and number of eCallers needed to attract the predatory animal. As shown in block 1104, a hunter may access the memory of one or more of the deployed eCaller speaker assemblies with a handset to examine and select the appropriate audio files for playback. As shown in block 1106, the hunter may also link the deployed eCallers through the user-interface of the handset. Linking the eCallers allows the user to enter one set of settings or configuration data for the hunt, whereby the appropriate settings will be propagated to all of the eCallers deployed. The hunter in linking the eCallers may also define or set the types of each of the eCallers so that the system may know the capabilities and features of each of the devices. For example, some of the eCaller devices may include a low/mid-range speaker, while others deployed may not. Configuration settings for eCallers may differ across different sizes and feature sets.

Once the eCallers are linked, the hunter may select on the handset the appropriate audio for playback, as shown in block 1108. The hunter may choose the appropriate audio depending on the predatory animal being lured, the environment in which the hunt is taking place, and/or the geographic location of the hunt. Using the handset, the selection of the audio to be broadcast may be transmitted to each of the eCallers and as shown in block 1110, the audio may be synchronously broadcast into the environment. The locations and conditions of the eCallers and their respective feature sets may determine how the processor of each speaker assembly playback the audio. If one or more eCallers are disposed far enough apart the respective processors of the eCallers much synchronize the playback of the audio to account for the distance, altering the time and level of the audio playback to ensure a predatory animal believes the audio is coming from a single location or source. While the audio is played out synchronously, the hunter may prepare and wait for the arrival of the predatory animal. If the conditions of the environment change or a different predatory animal is desired, the hunter may reconfigure the deployment of eCallers with the handset, rather than have to exert the time and energy physically attending to each device.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RANI from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A predator calling system comprising:
at least one speaker assembly comprising:
a plurality of speakers configured to emit sound;
a memory configured to store at least one of a plurality of audio files mimicking an animal;
a speaker assembly processor configured to play the at least one of a plurality of audio files from the speaker; and
a wireless transmitter configured to communicate with a handset;
the handset comprising:
a display;
a user-interface; and
a handset processor configured to:
present on the display a list the at least one of a plurality of audio files mimicking an animal;
receive a selection from a user of an audio file for playback; and
instruct the speaker assembly processor to play the selected audio file from the speaker.

2. The system of claim 1 further comprising:
a second speaker assembly in communication with the first speaker assembly and the handset;
wherein the speaker assembly processors of the first and second speaker assemblies are configured to synchronously play the at least one audio file.

3. The system of claim 2 wherein the playback of the at least one audio file of the first speaker differs in time and level from the playback of the at least one audio file by the second speaker.

4. The system of claim 2 wherein the speaker assemblies of the first and second speaker assemblies are configured to play audio files from the first and second speakers to mimic movement of an animal.

5. The system of claim 1 wherein the at least one audio file comprises an audio file mimicking a prey animal.

6. The system of claim 1 wherein the transmitter transmits at 915 MHz.

7. The system of claim 1 wherein the wireless transmitter is a Bluetooth transmitter.

8. The system of claim 1 further comprising a recording processor configured to record metadata relating to the playback of audio files, the metadata including at least one of: an audio file identification, a time stamp, duration of playback, and environmental data.

9. The system of claim 1 wherein the handset comprises a mobile telephone.

10. The system of claim 1 wherein the speaker assembly processor is further configured to store and play a predetermined and sequential list of audio files.

11. The system of claim 10 wherein the predetermined and sequential list of audio files is selected from the user-interface of the handset.

12. The system of claim 1 where in the speaker assembly further comprises a plurality of retractable legs.

13. The system of claim 1 wherein the plurality of speakers broadcasts in a 360° range.

14. The system of claim 1 wherein the plurality of speakers includes four full-range speakers and a low/mid-range speaker.

15. The system of claim 1 wherein the plurality of speakers includes three full-range speakers and a low/mid-range speaker.

16. The system of claim 1 further comprising a decoy device affixed to the at least one speaker assembly, the decoy device moveable by the speaker assembly processor.

17. The system of claim 1 wherein the at least one speaker assembly further comprises a nesting mechanism configured to secure an additional speaker assembly

18. A method of attracting a predatory animal comprising:
deploying a first and second speaker assembly in an environment, each speaker assembly comprising at least one speaker, a memory, a processor and a wireless transmitter;
accessing content of the memory of at least one of the speaker assemblies from a handset, the handset including a user-interface configured to display the content of the memory on a handset display;
linking the first and second speaker assemblies for synchronous playback;
selecting by the handset at least one audio file mimicking an animal;
synchronously broadcasting the at least one audio file from the first and second speaker assemblies.

19. The method of claim 18 further comprising broadcasting the at least one audio file from the first assemblies at a different time and level than the broadcast from the second speaker.

20. A system for attracting a predatory animal to a target area comprising:
a first speaker assembly disposed at a first location in the target area;
a second speaker assembly disposed at a second location in the target area;
each of the first and second speaker assembly comprising:
a plurality of speakers configured to emit sound in a range up to 360°;
a memory configured to store at least one of a plurality of audio files mimicking an animal;
a speaker assembly processor configured to play the at least one of a plurality of audio files from the speaker synchronously with other speaker assemblies; and
a wireless transmitter configured to communicate with a handset;
the handset comprising:
a display;
a user-interface; and
a handset processor configured to:
present on the display a list the at least one of a plurality of audio files mimicking an animal;
receive a selection from a user of an audio file for playback; and
instruct the speaker assembly processor to play the selected audio file from the speaker.
